(19) United States
(12) Patent Application Publication
(10) Pub. No.: US 2026/0050912 A1
(43) Pub. Date: Feb. 19, 2026

(54) Improvements In Or Relating To Data Integrity

(71) Applicant: Tokencertify Limited, Leeds (GB)

(72) Inventors: Adam BEAUMONT, Leeds (GB); Andrew MORRIS, Leeds (GB); Bill BRIGDEN, Leeds (GB)

(73) Assignee: Tokencertify Limited, Leeds (GB)

(21) Appl. No.: 18/876,659

(22) PCT Filed: Jul. 5, 2023
(86) PCT No.: PCT/GB2023/051779

§ 371 Date: Dec. 18, 2024

(30) Foreign Application Priority Data
Jul. 5, 2022 (GB) 2209881.8

(51) Int. Cl. G06Q 20/36

(52) U.S. Cl. CPC G06Q 20/3674

(57) ABSTRACT

There is disclosed a method of verifying transactions comprising assigning ‘trusted status’ a subset of users, the subset of trusted users defining a centralised root of trust, issuing one or more tokens from the centralised root of trust to users, submitting a transaction involving at least one token for verification by each of the subset of trusted users, determining whether or not a transaction is centrally verified based on whether or not a predetermined proportion of the trusted users have individually verified the transaction or not, and wherein if the transaction is centrally verified the transaction is recorded to a centralised ledger, and wherein if the transaction is not centrally verified, the transaction is not recorded to the centralised ledger. There is also disclosed a system for verifying transactions according to the above method.

### TECHNICAL FIELD OF THE INVENTION

The present invention relates to data integrity. Particularly, but not exclusively, it relates to a system, method, and service for providing data integrity to in relation to transactions.

### BACKGROUND TO THE INVENTION

Data integrity is a key tenet of transactions. Transactions, particularly transactions in which digital currency is used in favour of hard currency, are reliant upon the integrity of the currency and the ledgers upon which the transaction are recorded. Traditional digital currencies, as used in online transactions, use a centralised model to ensure data integrity, in that banks and governments can ensure the value of the currency used within the system, and thus the integrity of the associated transactions and ledgers. This is in contrast to cryptocurrencies, where a decentralised model (e.g., a blockchain) is used, and there is no singular entity which can ensure the integrity of the associates transactions and ledgers. Rather, the blockchains used in conjunctions cryptocurrencies are given integrity by multiple users (often hundreds if not thousands of users) checking each transaction and verifying its integrity. As can be expected, this model is highly inefficient, as it requires many users to perform checks for transaction recorded to each blockchain. This produces energy, cost and time inefficiencies.

Table 1 below shows data regarding the energy cost of transactions using various currencies, including cryptocurrencies and traditional currency.

| | | Energy Usage per |
|---|---|---|
| | Global Power Usage | Transaction |
| Platform | (kW) | (kWh/transaction) |
| Ethereum 2.0 (high | 1010.6-30887.5 | 0.00009-0.00286 |
| throughput projection) | | |
| Ethereum 2.0 (low | 1010.6-30887.5 | 0.01823-0.55713 |
| throughput projection) | | |
| Algorand | 6.2-189.3 | 0.00017-0.00534 |
| Cardano | 16.3-497.2 | 0.01239-0.37854 |
| Polkadot | 1.6-49.9 | 0.00378-0.11556 |
| Tezos | 2.2-67.1 | 0.00036-0.01096 |
| Hedera | 3.5-6.9 | 0.00002-0.00004 |
| Bitcoin | 3373287.7-34817351.6 | 360.39300-3691.40700 |
| VisaNet | 22387.1 | 0.00358 |

In contrast, a centralised system has the opposite problem, where the burden for verifying transactions and their integrity is incumbent upon a single institution, with little to no transparency as to how this is performed. This raises the issues that often the ledger of transaction is not viewable nor auditable by the public, which can lead to mistrust of the responsible institution. Further, having only a single institution be responsible for this create further time inefficiencies, as only the aforementioned institution is capable of verifying transactions.

It is an object of the present invention to provide a data integrity model which, at least partially, overcomes and/or ameliorates the above issues.

### SUMMARY OF THE INVENTION

According to a first aspect of the present invention, there is provided a method of verifying transactions comprising:
assigning ‘trusted status’ a subset of users, the subset of trusted users defining a centralised root of trust,
issuing one or more tokens from the centralised root of trust to users,
submitting a transaction involving at least one token for verification by each of the subset of trusted users,
determining whether or not a transaction is centrally verified based on whether or not a predetermined proportion of the trusted users have individually verified the transaction or not, and
wherein if the transaction is centrally verified the transaction is recorded to a centralised ledger, and wherein if the transaction is not centrally verified, the transaction is not recorded to the centralised ledger.

Provision of a centralised root of trust formed of a multiplicity of trusted users allows for a centralised ledger of verified transactions to be produced. This provides substantial efficiency improvements when compared to a decentralised model, where the ledger is distributed, and transaction need to be verified by many users individually. Using a predetermined proportion of trusted users to individually verify transactions also provides efficiencies over the fully centralised model (where there are no trusted users, and only one trusted central authority), as now the computational burden is distributed across the trusted users, which enables procedural efficiency. Unlike decentralised blockchain implementations, a centralised root of trust does not require the energy costs incurred due to Proof of Work or Proof of State (the conventional standards of proof for existing cryptocurrencies). This is enabled by the root verification of the trusted users. Equally the platform doesn't require the transaction to be replicated across multiple global nodes.

Table 2 shows the corresponding data to Table 1 above for the present invention, based on an estimate of 20000 transactions.

| | | Energy Usage per |
|---|---|---|
| | Global Energy Usage | Transaction |
| Platform | (kWh) | (kWh/transaction) |
| Present Invention | 0.225 | 0.00001125 |

According to a second aspect of the present invention, there is provided a system for verifying transactions comprising:
a centralised root of trust defined by a subset of trusted users, the centralised root of trust being operable to issue tokens to users,
a number of users operable to receive tokens, and perform transactions with them,
at least one server which contains a centralised ledger of centrally verified transactions, wherein the at least one server can only be written to by trusted users and/or by a non-trusted user given the authority to write to the at least one server by a predetermined proportion of the trusted users,
a number of individual verification units equal to the number of trusted users, via which the trusted users can each individually verify a transaction, and
a central verification unit operable to centrally verify transactions involving the tokens, where a transaction is only centrally verified if a predetermined proportion of the trusted users have individually verified that transaction, wherein centrally verified transactions are recorded to the centralised ledger.

A method as defined above enables greater procedural efficiency over both the decentralised and centralised models of transaction verification.

The trusted users may be selected private organisations, individuals, government entities, regulators and/or other stakeholders. The trusted users for any particular use of this method and system may be selected private organisations, individuals, government entities, regulators and/or other stakeholders from the particular industry or field in which the invention will be used. It will be understood that any number of users could be assigned trusted status, though it will typically be a small proportion of the total user base who are assigned trusted status. For example, the proportion of trusted users to non-trusted users may be 1:2, 1:5, 1:10, 1:25, 1:50, 1:100, or any suitable number, dependent upon the field. For example, if the tokens relate to financial instruments, such as a share in a company, there may only be several trusted users (such as banks and industry regulators), whilst there may be hundreds of thousands of non-trusted users. Conversely in other, more niche applications, there may be a lower proportion of trusted users to non-trusted users.

The tokens may be issued digitally. Additionally or alternatively, the tokens may be issued physically. Each token may have a fixed value. Alternatively, some or all tokens may have a value linked to one or more external factors.

The trusted users may each be assigned a partial, private key. The keys may be used to sign and create certificates. The keys may each create a partial certificate, which only becomes a (full) certificate when the required number of partial certificates has been created in respect of the relevant transaction. Alternatively, a certificate may only be created when the required number of partial keys have been applied to the transaction.

The keys may be used to verify externally generated data relating to a transaction. Any verified data may be issued a certificate of verification. Data which is not verified may not be issued a certificate.

There may be a certificate issued by each trusted user. Additionally or alternatively, a certificate may only be issued once the predetermined proportion of trusted users has verified the transaction. The certificates (and/or any metadata relating to the certificates) may be recorded to the ledger alongside the transaction to which the certificate relates.

The certificates may be encrypted using conventional encryption methods. The certificates may be compatible with conventional Public Key Infrastructure (PKI) methods. The certificates may be issued by an API, a web portal, or a dedicated application for this purpose.

The certificates may be issued in digital form. The certificates may be issued in physical form. The certificates may be digitally issued alongside a visual representation of the certificate. Such a visual representation of a certificate may be a QR code. The visual representation may be issued in physical form, such as a voucher comprising a QR code. Alternatively, the visual representation of the certificate may be applied to a pre-existing item, for example via laser engraving, etching, embroidery, printing, or the like.

The transaction may comprise the transfer of a token, the redemption of a token for a specified value, or the annulment of a token. It will be understood that not all transactions involving the tokens need verifying. For example, where a token can be redeemed in order to plant a tree, only the redemption of the token may be subject to central verification, and previous transfers of the token to the user who is redeeming the token may not be subject to central verification.

Transactions involving trusted users may be verified by default. Alternatively, transactions involving trusted users may still be subject to central verification. In such cases, the trusted users involved in said transaction may be excluded from the centralised root of trust for centrally verifying said transaction.

The predetermined proportion of trusted users may be a simple majority (i.e. above 50%) of the trusted users. Alternatively, depending on the transaction, a higher or lower proportion may be used. It will be understood that there are many possibilities for the predetermined proportion, including but not limited to 25%, 40%, 60% 75%, 80% and 100% of trusted users being required to verify the transaction. The predetermined proportion of trusted users may be variable. In such cases, the predetermined proportion of trusted users may be variable in line with the number of trusted users, number of total users, or number of transactions requiring verification.

The at least one server may be a hardened server. The at least one server may be operable to self-destruct when an unauthorised attempt to access the at least one server.

The ledger may be a quantum ledger. The ledger may be readable by any user (whether trusted or not). The ledger may be publicly accessible (for reading) through a standard internet browser. Additionally or alternatively, the ledger may be publicly accessible (for reading) via a dedicated interface, such as an application.

The ledger may only be written to by any of the trusted users. Alternatively, the ledger may be written to by any of the trusted users and/or non-trusted users who have been authorised to write to the ledger by the trusted users. In such cases, a predetermined proportion of the trusted users may be required to grant authorisation to the non-trusted user to write to the ledger. Where a non-trusted user has been authorised to write to the ledger, their changes to the ledger may be subject to further approval by one or more trusted users.

The authorisation of a non-trusted user may be time limited. The authorisation of a non-trusted user may be limited to a specific action. For example, a non-trusted user may be authorised only to record the details of a specific transaction to the ledger and have no further (writing) access to the ledger.

The method of the first aspect of the present invention may be used to verify encoded data in the form of two-dimensional barcodes. The two dimensional barcodes may be QR codes, UPC barcodes or any other suitable two-dimensional barcode.

The method of the first aspect of the present invention may be used to verify encoded data in the form of shortened URLs.

The method of the first aspect of the present invention may include any step performed by the components of the system of the second aspect as required or as desired, and, vice versa, the system of the second aspect may include components operable to perform any of the optional steps of the method of the first aspect as required or as desired.

Optional steps of the method of first aspect of the invention may be performed by components of the system of the second aspect of the invention without necessarily including a dedicated component for that purpose. Likewise, optional components of the second aspect of the invention may be able to perform steps of the method of the first aspect of the invention without explicitly stating this in reference to the second aspect the second aspect.

### DETAILED DESCRIPTION OF THE INVENTION

In order that the invention may be more clearly understood one or more embodiments thereof will now be described, by way of example only, with reference to the accompanying drawings, of which:

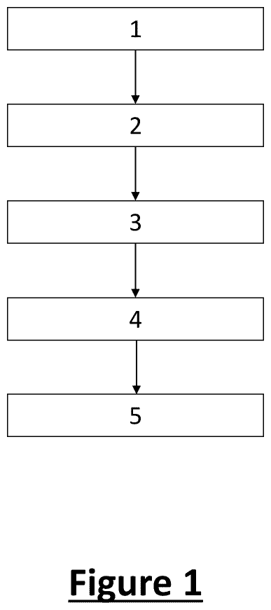

FIG. 1 shows a flow chart of an exemplary method according to a first aspect of the present invention.

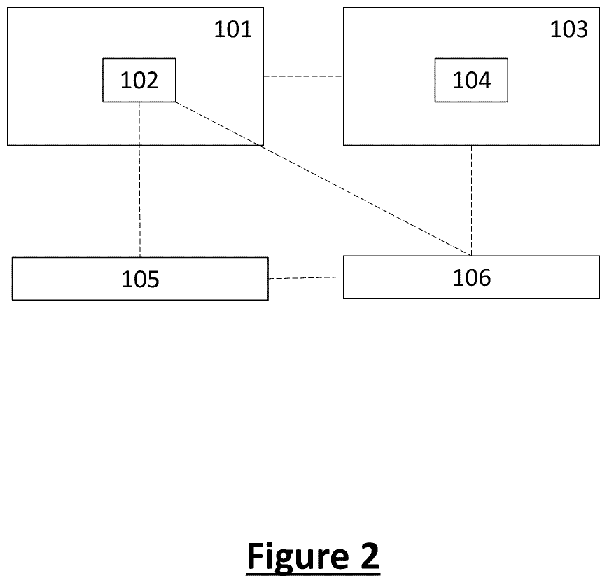

FIG. 2 shows a box diagram of an exemplary system according to the second aspect of the present invention.

Turning to FIG. 1, there is shown a method of verifying a transaction. The first step 1 of the method is to assign trusted status to a subset of users. At the second step 2, a token is issued to a user, in this example a non-trusted user. In this embodiment, the token is digital, and is redeemable in exchange for the planting of a tree. At some later time, a transaction is performed in respect of the token as shown in step 3. Step is a verification step, where the transaction is submitted to verification by the trusted users. Each trusted user is provided with the details of the transaction, and individually either verifies or declines to verify the transaction. The individual verification are recorded, and, if/once the predetermined proportion of trusted users have individually verified the transaction, then the transaction becomes centrally verified. If/once the transaction becomes centrally verified, the transaction (and the details thereof) are recorded to a centralised ledger, at step 5.

Turning now to FIG. 2, there is provided a number of users 101 of a system according to the present invention. A subset of these user are trusted users 102, who have been assigned ‘trusted status’. Trusted status enables the trusted users 102 to issue tokens to other users 101 (regardless of whether the users 101 to which the tokens are issued are trusted or not). Once the users 101 are issued tokens, the users 101 are free to perform transactions with the tokens. Certain transactions, such as redemption of the tokens for a given value, require central verification.

All users 101 (include the trusted users 102) have read only access to a server 103. The server 103 contains a ledger 104 which comprises details of all centrally verified transactions performed in relation to the tokens.

When a transaction between users 101 occurs, the details of the transactions are sent to the rusted users 102. Each trusted user 102 has access to an individual verification unit 105. The trusted users 102 use their respective individual verification units 105 to individually verify the transaction (or to reject the transaction). Individual verification comprises the assigning of a partial private key to the transaction details by the individual verification unit 105. Once a predetermined proportion of the trusted users 102 have individually verified the transaction, the transaction is deemed to qualify for central verification, and the details of said transaction are passed to a central verification unit 106, alongside the respective partial private keys.

The central verification unit 106 is operable to verify the presence of the partial private keys, and thereby to create a (complete) private key and assign it to the transaction. The central verification unit 106 is operably connected to the server 103, in a manner which allows the central verification unit 106 to write details of centrally verified transactions and the respective keys to the ledger 104. The ledger 104 is readable by any of the users 101, allowing for the centrally verified transactions to be audited.

In order to aid in understanding of the invention, a set of non-limiting examples are illustrated below to show the operation of the present invention.

In a first exemplary implementation of the present invention, there is provided a token system for use in planting of trees in forests. As it is becoming increasing common for trees to be planted by corporations in order to offset their carbon emissions, it is necessary that there is some level of verification of the planting of trees to avoid fraud occurring, and to provide an auditable history of any trees which have been planted using the token system.

In this scenario, the users are any person who may acquire a token to plant a tree. This includes corporations and individuals, who may, for example, wish to gift the token to plant a tree to a friend. In this scenario, the trusted users are the tree planting companies, relevant industry regulators/authorities (for example a government department with oversight of such companies), and any environmental charities.

In this exemplary scenario, tokens are issued from the tree planting companies, and/or relevant charities (who are, as above, trusted users). The tokens are issued by these trusted users in digital form to whomever purchases the tokens, and therefore are likely to be obtained by non-trusted users (though it would also be possible for trusted users to obtain the tokens).

In order to plant a tree, a user must redeem a token for this purpose. It will be understood that a token could be redeemed to plant more than one tree, but in this exemplary scenario a token is redeemable to plant a single tree. However, the redemption of a token were not verified, then counterfeit tokens could be redeemed, or the redemption of a token could be subject to other fraudulent acts.

As such, upon redemption of token, the details of the redemption transaction are submitted to each trusted user for verification. In this embodiment, the verification process includes cross-referencing the meta-data of the token (for example issue date, issue number etc.) with a database of previously issued (and unredeemed) tokens. If the token does not match the metadata of an unredeemed token, then each trusted user will not verify the transaction, and the token will remain unredeemed (and no tree shall be planted).

In the scenario where the metadata of the token to be redeemed is the same as an issued and as yet unredeemed token, then each trusted user may verify the transaction. In a fully decentralised system, all users would need to verify this individually. However, according to the present invention, only a predetermined proportion of the trusted users must individually verify the transaction in order for the transaction to become centrally verified.

In this example, the predetermined proportion of trusted users is 50%. Therefore if, for example, there are three trusted users in total, then only two trusted users (say) would need to individually verify the redemption before the transaction becomes centrally verified. Say, for example, the trusted parties are two tree planting companies and a government authority overseeing their operations, then only the planting company where the token is redeemed, and the government authority would be required to individually verify the transaction. It will be understood that, if more efficient or if required by the circumstances, the tree planting company which is involved in the transaction may or may not be one of the trusted users to individually verify the transaction. The central verification is contingent upon the predetermined proportion of trusted users verifying the transaction, not that specific trusted users have verified the transaction.

This verification process enables increased efficiency of the verification process, as it saves the need for the third trusted user to use time and energy to verify the transaction. It will be understood that in implementations where there are many trusted users (for example in banking and/or healthcare scenarios), that even greater efficiencies are provided by the present invention.

Once the transaction is centrally verified, the details of the transaction are written to a centralised ledger by one of the trusted parties, in this case the tree planting company which has planted the tree. The details recorded to the ledger include the time of planting, the identity of the user who redeemed the token, the species of the tree and the position of the tree within the plot, amongst any other details, as will be understood by the skilled person. In this exemplary scenario, the centralised ledger is a ‘quantum ledger’ which can only be written to by the trusted users but is readable by any user. This ensures the integrity of the ledger, and also allows, for example, a (non-trusted) user who redeemed the token to find the details of ‘their’ tree within the ledger.

In a second exemplary scenario, the present invention is implemented so as to prevent fraud in relation to recycling. To promote recycling, many governments offer a small monetary incentive to recycle plastic bottles (and/or other recyclable items). However, this is open to fraud as some users may attempt to defraud the system by ‘trading in’ non-recyclable bottles (or bottles not eligible for the cash reward). Therefore, verifying the origin and eligibility of bottles becomes a necessity.

In this scenario, the trusted users are bottle manufacturers, the relevant recycling companies and the government department who are offering the monetary incentive. Here, the (non-trusted) users are any individual or company are able to purchase or receive an eligible bottle.

In the example, the tokens are applied physically to each eligible bottle in the form of a QR code. Each QR code provides information on the manufacture of the bottle, whether or not it is eligible to be exchanged for a monetary incentive and whether or not the bottle has been previously exchanged for a monetary incentive. Again, other details may be provided via the QR code as required.

In order to acquire the monetary incentive, the user in possession of the bottle must redeem the bottle via a recycling company (which will be a trusted user as above). The receipt of the monetary incentive by the user will be subject to central verification of the bottles eligibility. Once the QR code is scanned, the details of the bottle, including whether or not the bottle is eligible for redemption for the monetary incentive, and whether or not the bottle has already been so redeemed are submitted to the trusted users, alongside the other transaction details.

In this exemplary scenario, there are five trusted users-three recycling companies, one government department and a bottle manufacturer, and the predetermined proportion of trusted users required for central verification is 25%. Therefore, only two of the five trusted users are required to verify the transaction individually. As illustrated above, for central verification to occur it is not relevant which two trusted users individually verify the transaction, and indeed, it may be two trusted users which have played no part in the transaction itself.

Once the transaction has been centrally verified, the details of the transaction are written to the centralised ledger. This allows a record of the transaction in order to ensure auditability of the process and allows for analysis of all recorded transactions (for example to detect fraud or unusual patterns of transactions).

A third exemplary implementation of this invention is in supply chain verification. In this scenario, a transaction is created and centrally verified, as an item is worked through the supply chain. Each logical interaction between the item and a supplier is verified to the root transaction and an audit record is created. Each interaction can be individually verified by trusted users, which leads to central verification and the transaction being written to the centralised ledger (providing the predetermined proportion of trusted users individually verify the transaction). This provides a cryptographically verifiable audit record for an item through all aspects of the supply chain.

A fourth exemplary implementation of this invention is in verification of vaccination. In this scenario, the production of the vaccine is verifiable according to the supply chain verification example given above. Furthermore, details of the vaccine delivery (such as location and batch) can be centrally verified and written to the centralised ledger, thus providing a cryptographically verifiable record of vaccination, which includes details of the vaccine manufacture right through to the details of the end delivery of the vaccine.

Another exemplary embodiment of the invention is the verification of encoded data. Examples of such encoded data include shortened URLs and QR codes. For this example, the trusted users are URL shortening companies, companies who generate QR codes for third parties, and the companies who are using these URL shortening/QR code generating companies. A user scanning a QR code or following a shortened URL will be lead to an intermediate platform, wherein the details of the transaction (such as the validity of the QR code/URL, date of creation of the code/URL and the destination of the QR code/URL) can be shown. These details can be verified by the trusted users (or a subset thereof), and the transaction can thus be verified and written to a centralised ledger. In this scenario, the transaction details can be pre-verified by the platform, such that a previously verified QR code does not need to re-verified every time it is used.

The one or more embodiments are described above by way of example only. Many variations are possible without departing from the scope of protection afforded by the appended claims.

1. A method of verifying transactions comprising:
assigning ‘trusted status’ a subset of users, the subset of trusted users defining a centralised root of trust,
issuing one or more tokens from the centralised root of trust to users,
submitting a transaction involving at least one token for verification by each of the subset of trusted users,
determining whether or not a transaction is centrally verified based on whether or not a predetermined proportion of the trusted users have individually verified the transaction or not, and
wherein if the transaction is centrally verified the transaction is recorded to a centralised ledger, and wherein if the transaction is not centrally verified, the transaction is not recorded to the centralised ledger.

2. (canceled)

3. (canceled)

4. A method according to claim 1 wherein the ledger can only be written to by any of the trusted users.

5. A method according to claim 1 wherein the ledger can be written to by any of the trusted users and/or non-trusted users who have been authorised to write to the ledger by the trusted users.

6. A method according to claim 5 wherein a predetermined proportion of the trusted users is required to grant authorisation to the non-trusted user to write to the ledger.

7. A method according to claim 1 wherein the predetermined proportion of trusted users is a simple majority.

8. A method according to claim 1 wherein the predetermined proportion of trusted users is variable.

9. A method according to claim 8 wherein the predetermined proportion is variable in line with the number of trusted users, number of total users, or number of transactions requiring verification.

10. A method according to claim 1 wherein the trusted users are each assigned a partial, private key.

11. (canceled)

12. A method according to claim 10 wherein any verified data is issued a certificate of verification.

13. A method according to claim 12 wherein there is a certificate of verification is issued by each trusted user.

14. A method according to claim 12 wherein the certificate/s and/or any metadata relating to the certificate/s are recorded to the centralised ledger alongside the transaction to which the certificate/s relates.

15. (canceled)

16. (canceled)

17. (canceled)

18. A method according to claim 1 wherein the method is used to verify encoded data in the form of two-dimensional barcodes.

19. A system for verifying transactions comprising:
a centralised root of trust defined by a subset of trusted users, the centralised root of trust being operable to issue tokens to users,
a number of users operable to receive tokens, and perform transactions with them,
at least one server which contains a centralised ledger of centrally verified transactions, wherein the at least one server can only be written to by trusted users and/or by a non-trusted user given the authority to write to the at least one server by a predetermined proportion of the trusted users,
a number of individual verification units equal to the number of trusted users, via which the trusted users can each individually verify a transaction, and
a central verification unit operable to centrally verify transactions involving the tokens, where a transaction is only centrally verified if a predetermined proportion of the trusted users have individually verified that transaction, wherein centrally verified transactions are recorded to the centralised ledger.

20. A system according to claim 19 wherein the at least one server is a hardened server.

21. A system according to claim 19 wherein the at least one server is operable to self-destruct when an unauthorised attempt to access the at least one server is made.
